(19) United States
(12) Patent Application Publication
(10) Pub. No.: US 2006/0064451 A1
(43) Pub. Date: Mar. 23, 2006

(54) Arithmetic circuit

(76) Inventor: Kalpesh Dhanvantrai Mehta, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/944,520

(22) Filed: Sep. 17, 2004

(51) Int. Cl. G06F 7/38

(52) U.S. Cl. 708/524

(57) ABSTRACT

A system is described for processing data through single instruction multiple data (SIMD) operations. The system is coupled to receive a first operand and second operand, each of the operands having a length of N*M-bits. In one embodiment, N is an integer equal to or greater than two and M is an integer equal to or greater than two. The first operand is combined with first N-extra bits and are stored in a first (N*M)+N-bit register. The second operand is combined with a second N-extra bits and stored in a second (N*M)+N-bit register. The system logically combines values in the first register and the second register to obtain a result data having a length of N*M-bits. Other embodiments are described and claimed.

### BACKGROUND

Embodiments of the invention relate to systems for processing data, and more specifically, to a system for processing data through single instruction multiple data (SIMD) operations.

Arithmetic instructions, such as add and subtract, are some of the most basic and widely used instructions in any given program. Processors typically support some sort of single instruction multiple data (SIMD) instructions. SIMD processing enable multiple operands within a register to be processed in parallel. Processors support various types of SIMD/non-SIMD instructions, including, but not limited to, 16-bit single add instructions, 8-bit dual (two-way) add instructions, 16-bit add with carry instruction, 8-bit dual (two-way) add with carry and the like. A SIMD adder may be used to perform either one 16-bit addition for the 16-bit add instruction or two 8-bit additions in parallel for the 8-bit dual add instruction. The 16-bit add with carry instruction adds a carry from the previous operation to the operands.

One way of implementing SIMD adders is to use two 8-bit adders with intervening logic that determines the carry propagation. For a 16-bit operation, the carry is propagated from a lower 8-bit adder to an upper 8-bit adder of the operands. For dual 8-bit operation, the carry propagation is inhibited.

### BRIEF DESCRIPTION OF THE DRAWINGS

The invention is illustrated by way of example and not by way of limitation in the figures of the accompanying drawings in which like references indicate similar elements. It should be noted that the references to “an” or “one” embodiment of this disclosure are not necessarily to the same embodiment, and such references mean at least one.

FIG. 1A is a diagram used to illustrate the operation of an arithmetic circuit according to one embodiment when it operates as a 16-bit adder.

FIG. 1B is a diagram used to illustrate the operation of an arithmetic circuit according to one embodiment when it operates as four 8-bit adders.

FIG. 2 is a block diagram illustrating a processor including a single instruction multiple data (SIMD) arithmetic circuit, in accordance with one embodiment.

FIG. 3 is a block diagram further illustrating the processor of FIG. 2, in accordance with one embodiment.

FIG. 4 is a block diagram illustrating a digital media processor, in accordance with one embodiment.

FIG. 5 is a block diagram illustrating various design representations or formats for simulation, emulation and fabrication of a design using the disclosed techniques.

### DETAILED DESCRIPTION

In the following description, specific details are set forth. However, it is understood that embodiments described may be practiced without these specific details. In other instances, well-known circuits, structures and techniques have not been shown in detail to avoid obscuring the understanding of this description.

Conventional techniques for implementing a 16-bit adder use two 8-bit adders with intervening logic that determines the carry propagation. For a 16-bit operation, the carry is propagated from a lower 8-bit adder to an upper 8-bit adder of the operands. For dual 8-bit operation, the carry propagation is inhibited. One of the main disadvantages of using two 8-bit adders with intervening logic is the speed that can be achieved. For example, a synthesis tool may realize each of the 8-bit adders with the fastest adder architecture possible, but since there is carry propagation across adders, the speed of the overall adder is limited by it. The carry related decision logic is in critical path causing the design to run more slowly.

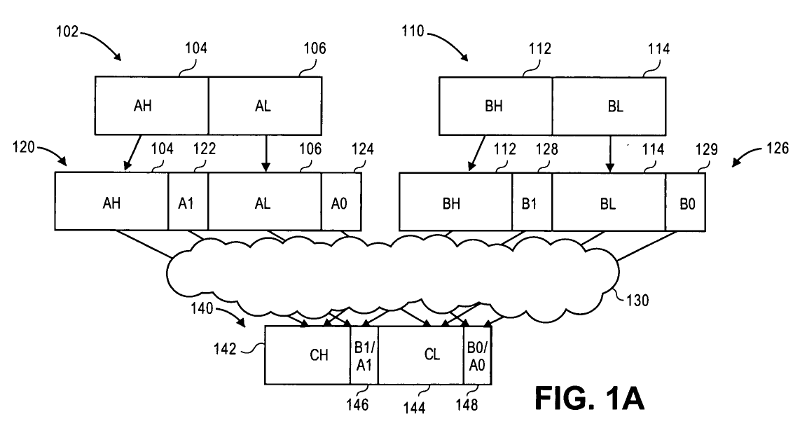

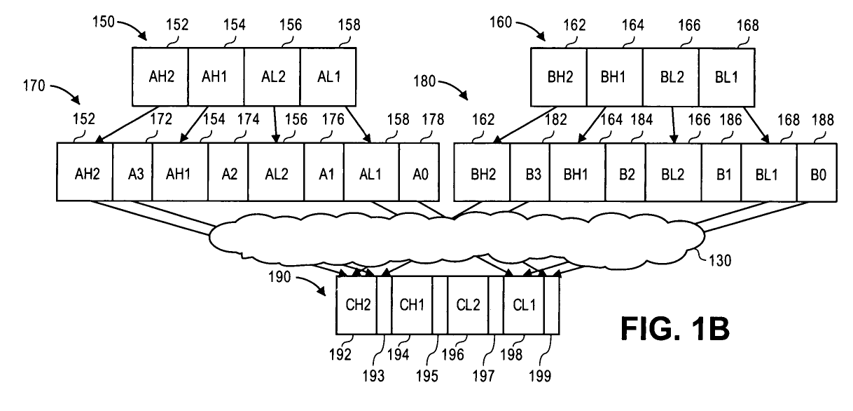

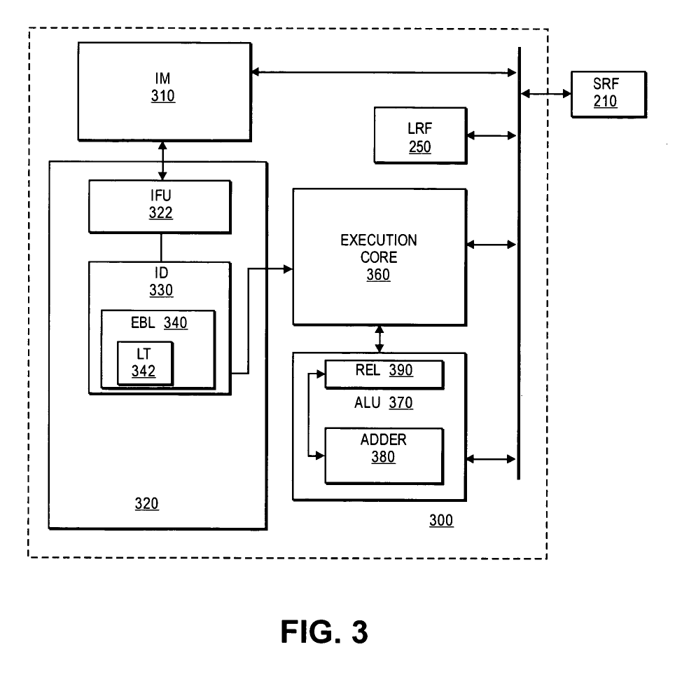

FIG. 1A is a diagram used to illustrate the operation of an arithmetic circuit according to one embodiment when it operates as a 16-bit adder, for adding two 16-bit numbers. Representatively, two operands A 102 and B 110 are associated with an instruction fetched by, for example, an instruction fetch unit (IFU) (e.g., WFU 322 of FIG. 3). The operation performed by arithmetic circuit 130, according to one embodiment, is A+B+Carry (Cin). Advantageously, there are no conditions to determine if a carry needs to be added from intervening carry logic or propagated to an upper byte.

Representatively, operand 102 includes lower byte value (AL) 106 and upper byte value (AH) 104. Likewise, operand 110 includes lower byte value (BL) 114 and upper byte value (BH) 112. An instruction decode stage (e.g., front end logic 320 of FIG. 3) determines the appropriate values of bit values (“data flags”) A0 124, A1 122, B0 134, B1 132 and packs the data flags A0 124, A1 122, B0 129, B1 128 with first operand 102 and second operand 110 into first and second registers 120 and 126, which have a length of 18 bits ((2*8)+2). Next, arithmetic circuit 130 performs a single arithmetic operation to obtain an 18-bit intermediate result within register 140. In one embodiment, result extraction logic (not shown) extracts lower byte value (CL) 144 and upper byte value (CH) 142 while ignoring data flag fields 146 and 148 to obtain a 16-bit result that represents an arithmetic operation upon values of operands 102 and 110.

As further illustrated with reference to FIGS. 1A and 1B, setting of data flags A1 122 and B1 128 to zero cuts-off carry propagation generated by the sum of AL 106+BL 114 (“lower byte sum”). Conversely, setting of bit B1 128 enables carry propagation from the lower byte sum to the sum AH 102+BH 110 (“upper byte sum”). Likewise, setting of data flags A0 124 and B0 129 to zero cuts-off any carry-in values generated in response to a carry flag, which would be added to the lower byte sum. Conversely, setting of either data flags B0 129 or A0 124 enables carry-in propagation to the lower byte sum from a previous stage. Likewise, the setting of either data flags B1 128 or A1 122 and the setting of either data flag A0 124 or data flag B0 134 enables carry propagation for any carry-in propagation, as well as carry propagation from the lower to the upper byte sum. In one embodiment, rounding operations are achieved by setting data flags A0 124 and B0 129 and carry propagation to the upper byte sum may also be enabled by setting data flag B1 128 to a value of one.

As illustrated in FIG. 1A, a result generated by arithmetic circuit 130 is stored in register 140. Representatively, an upper byte value within register 140 (CH) is the upper byte sum and any carry-in, depending on the setting of either data flags A1 122 or B1 128. Likewise, a lower byte value (CL) of register 140 is comprised of the lower byte sum, which may include a carry-in from, or according to, the setting of data flags A0 124 or B0 129. Accordingly, in one embodiment, to provide a proper result to a subsequent stage, such as a retirement stage, result values CH 142 and CL 144 and are extracted and stored within a register for the subsequent stages. Accordingly, in one embodiment, the positions 146 and 148 of register 140 are ignored to provide, for example, a 16-bit result from the 18-bit value stored within register 140.

FIG. 1B is a diagram used to illustrate the operation of arithmetic circuit 130 according to one embodiment when it operates as four 8-bit adders. Representatively, operand 150 includes first lower byte value (AL1) 158, second lower byte value (AL2) 156, first upper byte value (AH1) 154 and second upper byte value (AH2) 152. Likewise, operand 160 includes first lower byte value (BL1) 168, second lower byte value (BL2) 166, first upper byte value (BH1) 164 and second upper byte value (BH2) 162. Once the corresponding byte values of operands 150 and 160 are packed with the data flags (A3 172, A2 174, A1 176, A0 178, B3 182, B2 184, B1 186 and B0 188) and stored within first register 170 and second register 180, which each have a length of 36-bits (4*8+4), arithmetic circuit 130 performs a four-way SIMD operation to generate a 36-bit result within output register 190. In one embodiment, result extraction logic (not shown) extracts first lower byte value (CL1) 194, second lower byte value (CL2) 196, first upper byte value (CH1) 197 and second upper byte value (CH2) 192 while ignoring extra bit result fields 193, 195, 197 and 199.

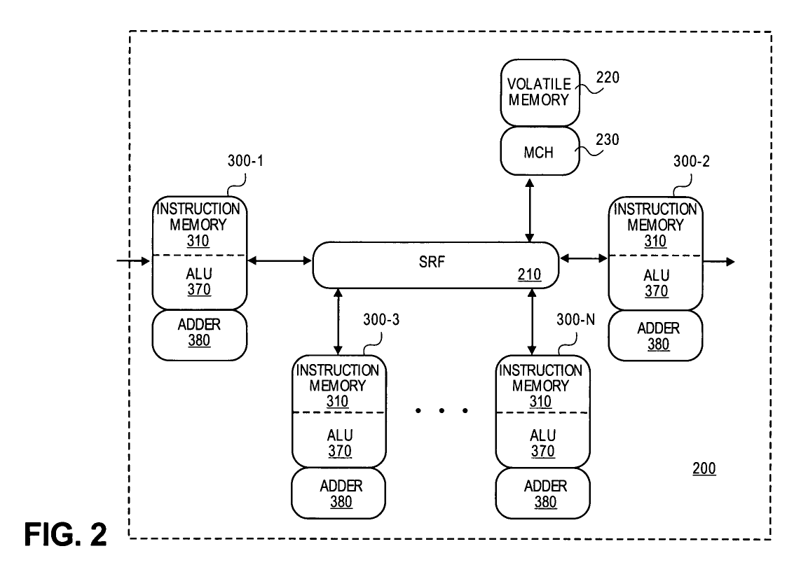

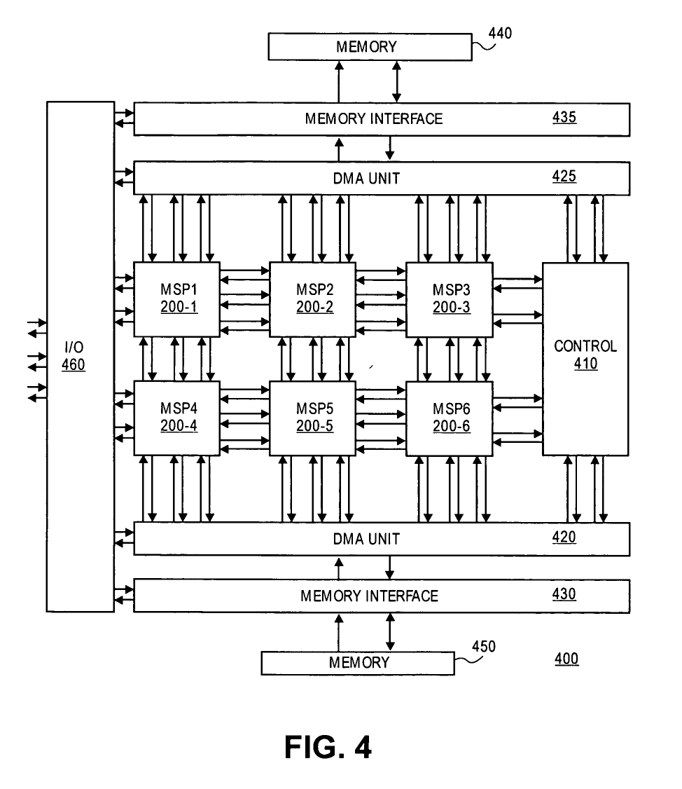

FIG. 2 is a block diagram illustrating a processor 200 including an arithmetic logic unit 370 having a single instruction multiple data (SIMD) arithmetic circuit (adder) 380, in accordance with one embodiment. In one embodiment, processor 200 is referred to herein as a “media signal processor”, which may function according to a data driven architecture. In one embodiment, a plurality of processors 200, as shown in FIG. 2, may be coupled together to form digital media processor 400 as shown in FIG. 4. In one embodiment, digital medial processor 400 provides a data driven architecture for performing data intensive applications, such as media processing applications, including, but not limited to, video processing, image processing, sound processing, security based applications and the like.

As shown in FIG. 2, media signal processor (MSP) 200 includes one or more processing elements (PEs) 300 (300-1, . . . , 300-N). Representatively, each PE 300 is coupled to shared register file (SRF) 210. SRF 210 allows PEs 300 to exchange and store data within general purpose registers (GPRs) of register file 210. Representatively, MSP 200 includes internal volatile memory 220 for local data and variable storage, as well as memory command handler (MCH) 230 to alleviate bandwidth bottlenecks on the off chip memory. In one embodiment, PEs 300 are the basic building blocks of MSP 200 and may include instruction memory 310 to support an instruction set designed to provide flow control, arithmetic logic unit functions and custom interface functions, such as multiply-accumulate instructions, bit rotation instructions, or the like.

As such, depending on the function MSP 200 is designed to perform, PEs 300 may be divided to accomplish the desired functionality and parallel performance of algorithmic portions of a media processing application executed by a digital media processor, for example as shown in FIG. 4. In one embodiment, a general processing element (GPE) is the basic processing element upon which more complicated PEs may be generated. In one embodiment, PEs may be categorized as: input processing elements (IPE), which are connected to input ports to accept incoming data streams; general processing elements (GPE), multiply accumulate processing elements (MACPE); and output processing elements (OPE), which are connected to output ports to send outgoing data streams for performing desired processing functionality.

FIG. 3 is a block diagram further illustrating front end logic 320 and execution core 360 of PEs 300 of FIG. 2, in accordance with one embodiment. Although FIG. 3 illustrates an execution architecture of PEs 300 of FIG. 2, it should be recognized that FIG. 3 may illustrate an execution architecture of a processor that does not include processing elements. Accordingly, it should be recognized that a SIMD arithmetic circuit, as described herein, is not limited to media signal processors and can be incorporated within the execution architecture or micro-architecture of conventional processor architectures, to provide high speed addition, subtraction and other like arithmetic functions while avoiding intervening carry logic that places a carry-related decision in the critical path causing conventional adder designs to run more slowly.

In one embodiment, operation of adder 380 requires population of one or more extra bit values packed with the one or more operands of a received instruction (see FIGS. 1A and 1B). Accordingly, rather than using multiple adders with intervening carry logic, in one embodiment, SIMD adder 380 is generated with the synthesis tool to provide a high-speed adder architecture. In one embodiment, as shown in FIGS. 1A and 1B, a 16-bit SIMD adder is realized using an 18-bit adder and 4-way, 8-bit SIMD adder is realized using a 36-bit adder, respectively. To provide such functionality, in one embodiment, the one or more extra bits are packed together with the one or more operands in a decode stage of an execution pipeline of a processor, as shown in FIG. 3.

Representatively, instruction fetch unit (IFU) 322 is coupled to receive first and second operands associated with an instruction fetched from instruction memory (IM) 310. In one embodiment, the first and second operands each have a length of N*M-bits. In one embodiment, instruction decoder (ID) 330 stores the first N*M-bit operand and a first N-extra bits in a first N*M+N-bit register. Likewise, ID 330 stores the second N*M-bit operand and a second N-extra bits in a second N*M+N-bit register. In one embodiment, ID 330 uses local register file (LRF) 250 for the first and second N*M+N-bit registers. In one embodiment, N is an integer equal to or greater than two and M is an integer equal to or greater than two.

In one embodiment, extra bit logic (EBL) 340 may query look-up table (LT) 342 to determine a value of the first and second N-extra bits added to the first and second operands, respectively. In one embodiment, EBL 340 queries LT 342 according to an operation requested by an instruction received from WU 322. In one embodiment, the requested operation is determined according to an opcode, or other like designation of the instruction. As described herein, the first and second N-extra bits are referred to as “data flags”, which may be used to determine whether a carry is propagated from a lower byte value or prior stage and may be used to perform rounding and other like functions.

Accordingly, in one embodiment, EBL 340 populates first and second N-bit data flags to enable (N*M)+N-bit adder 380 to perform an addition operation or other like requested operation. In one embodiment, N*M bit result is extracted by result extraction logic (REL) 390 from an (N*M)+N-bit result generated by adder 380. For example, in one embodiment, adder 380 operates as an 18-bit adder, as shown in FIG. 1A. Representatively, ID 330 receives first and second 16-bit operands and stores each of the first and second 16-bit operands and two data flags in an 18-bit register. In one embodiment, each of the 18-bit registers, including the first and second input operands and first and second data flags, are provided to adder 380 to generate an 18-bit sum. REL 390 with adder 380 logically combines values in the first and second registers to obtain a result data having a length of 16-bits, for example, as shown in FIG. 1A.

As illustrated in FIG. 1A, PE 300 enables SIMD operation of adder 380 according to one embodiment where SRF 210 and LRF 350 work on either 16-bit integers or dual 8-bit integers. In one embodiment, EBL 340 of ID 330 adds data flags to operands 102 and 110 in the decode stage of the pipeline at positions shown in FIG. 1A. Representatively, data flags A0 124 and A1 122 are added at position 0 and position 9 of operand 102, which are stored in register 120. Likewise, EBL 340 adds data flags B0 129 and B1 128 at position 0 and position 9 of operand 110, which are stored in register 130. As described herein, the terms “set” or “assert” as well as “reset” or “deassert” do not imply a particular logical value. Rather, a bit may be set to “1” or set to “0” and both are considered embodiments of the invention. As a result, a bit may be active “0” (asserted low signal) or active “1” (asserted high signal) in accordance with the embodiments described herein.

TABLE ONE

| OPCODE | dual | cin | adsWrnd | A1 | B1 | A0 | B0 | Category |
|---|---|---|---|---|---|---|---|---|
| addop | 0 | 0 | x | 0 | 1 | 0 | 0 | add (single mode, no carry |
| | | | | | | | | in) |
| addop | 0 | 1 | x | 0 | 1 | c1 | 1 | add (single mode, carry in) |
| addop | 1 | x | x | 0 | 0 | 0 | 0 | add (dual mode add, no |
| | | | | | | | | carry in) |
| adsop | 0 | x | 0 | 0 | 1 | 0 | 0 | ads (single mode add and |
| | | | | | | | | shift, no rounding) |
| adsop | 0 | x | 1 | 0 | 1 | 1 | 1 | ads (single mode add and |
| | | | | | | | | shift, with round) |
| adsop | 1 | x | 0 | 0 | 0 | 0 | 0 | ads (dual mode add and |
| | | | | | | | | shift, no carry) |
| adsop | 1 | x | 1 | 1 | 1 | 1 | 1 | ads (dual mode add and |
| | | | | | | | | shift, w/rounding) |
| subop | 0 | 0 | x | 0 | 1 | 1 | 1 | sub (subtract. single mode) |
| subop | 0 | 1 | x | 0 | 1 | b1 | 1 | sub (subtract. single mode, |
| | | | | | | | | with borrow) |
| subop | 1 | x | x | 1 | 1 | 1 | 1 | sub (dual mode subtract, no |
| | | | | | | | | borrow) |
| absop | 0 | x | x | 0 | 1 | 1 | 1 | abs (absolute operation, |
| | | | | | | | | single mode) |
| absop | 1 | x | x | 1 | 1 | 1 | 1 | abs (absolute operation, dual mode) |
| abdop | 0 | x | x | 0 | 1 | 1 | 1 | sub (absolute difference |
| | | | | | | | | single mode) |
| abdop | 1 | x | x | 1 | 1 | 1 | 1 | sub (absolute difference, |
| | | | | | | | | dual mode) |

In one embodiment, EBL 140 determines values of data flags A0, A1, B0, B1 (see FIGS. 1A and 1B) from LT 342 based on a type of operation being performed and stores the result in registers 120 and 130, respectively. In one embodiment, LT 342 is populated according to Table 1. Representatively, the populating of data flags A0 124, A1 122, B1 128 and B0 129 enables several addition operations, including single mode with or without carry-in, as well as dual mode addition. In the embodiments described for 16-bit operands, dual mode performs dual 8-bit operations. In addition, Table 1 provides values to enable addition with rounding for single mode or dual mode, which may include shifting, such as, for example, required to perform averaging functions. Representatively, the populating of data flags A1, B1, A0 and B0, enable additional operations, including subtraction operations and absolute difference operations to be performed using a single arithmetic circuit.

Referring again to FIG. 1A, in one embodiment, for example, for 16-bit ADD instruction (ADDU), data flags A0 124, B0 129, A1 132 are set to zero and data flag B1 128 is set to one. Any carry generated by the lower byte sum is propagated to the upper byte sum. For 8-bit Dual ADD instruction (ADDUU), data flags A0 124, B0 129, A1 122, B1 128 are all set to zero. Thus the carry generated by the lower byte sum is inhibited from propagating to upper byte sum to provide the dual add operation with adder 380 (FIG. 3).

For 16-bit ADD with Carry instruction, data flags A0 124 and A1 122 are set to zero and data flags B0 129 and B1 128 are set to one. If the carry flag (Cin) was set, then one is added to the lower byte sum. Also, any carry generated by the lower byte sum is propagated to the upper byte sum. For 16-bit ADD, SHIFT and ROUND instruction, data flags A0 124, B0 129 are set to one, data flag A1 122 is set to 0 and data flags B1 128 is set to one. As a result, there is carry out of A0/B0 stage (since A0=1 and B0=1) that is added to the sum for rounding purposes. The result is shifted right by one position to perform a division by two operation using, for example, a shifter of ALU 370. In addition, there is carry propagation from lower byte sum to upper byte sum.

For 8-bit Dual ADD, SIFT and ROUND instruction, data flags A0 124, B0 129, A1 122, B1 128 are all set to one. As can be seen from the foregoing description, by setting data flags A0 124, A1 122, B0 129, B1 128 according to, for example Table 1, various kinds of arithmetic operations are provided by a simple 18-bit adder. The logic can be extended to subtractors by generating a complement value of one of the operands and populating the data flags (A1 132, A0 124, B1 128 and B0 129) according to Table 1. The logic can also be extended to more than two-way SIMD, for example, as shown in FIG. 1B for four-way SIMD.

As illustrated in FIG. 1B, operation of PE 300 enables SIMD operation of adder 380 according to one embodiment where GPR 210 and LRF 350 work on either 32-bit (quad word) integers, dual 16-bit integers or quad 8-bit integers. Representatively, operand 150 and operand 160 are associated with an instruction fetched by, for example, EFU 322 of FIG. 3. As described above, the operation performed by adder 380 is A+B+Cin. In one embodiment, EBL 340 packs a data flag adjacent to a least significant bit of each 8-bit value of operands 150 and 160.

FIG. 4 shows a plurality of MSPs 200 (200-1, . . . , 200-6) coupled together to form a media processor 400 according to one embodiment. As illustrated, MSPs 200 include various ports that enable bi-directional data connection that allows data to flow from one unit to another. As such, each port has the ability to send and receive data simultaneously through various separate uni-directional data buses. In one embodiment, the various ports of the MSPs 200 include first in first out (FIFO) devices in each direction between two units, controlled via, for example, a port selection register.

Accordingly, any port in a unit can connect to a port of each of the other MSPs 200 which may utilize a data bus, which is, for example, 16 bits wide. Accordingly, media processor 400 utilizes the plurality of MSPs 200 to freely exchange and share data, which accelerates the performance of data intensive applications, such as audio, video and imaging applications. In one embodiment, media processor 400 is coupled to memory 450 and 440, which are, for example, dual data rate (DDR) synchronous data random access memory (SDRAM) which run at, for example, 133 MHz (266-MHz DDR devices).

In one embodiment, digital media processor 400 is used within video processing applications, image processing applications, audio processing applications, or the like. In addition, by incorporating a SIMD arithmetic circuit, such as for example, adder 380, media processor 400 provides high-speed arithmetic operations required by media processing applications. In addition, media processor 400 includes memory access units 420 and 425, as well as memory interface units 430 and 435. Likewise, input/output (I/O) block 460 provides access to various I/O devices.

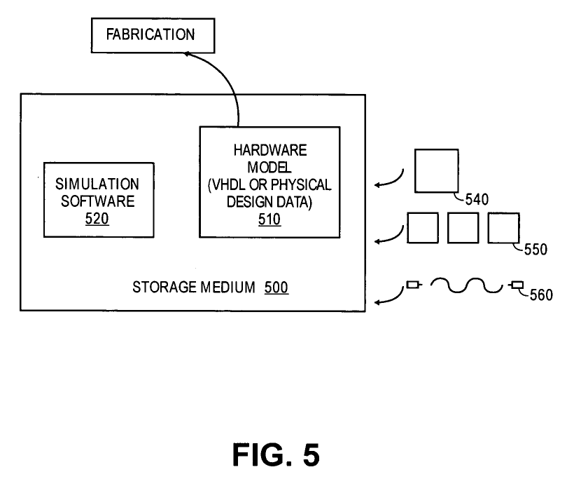

FIG. 5 is a block diagram illustrating various representations or formats for simulation, emulation and fabrication of a design using the disclosed techniques. Data representing a design may represent the design in a number of manners. First, as is useful in simulations, the hardware may be represented using a hardware description language, or another functional description language, which essentially provides a computerized model of how the designed hardware is expected to perform. The hardware model 510 may be stored in a storage medium 500, such as a computer memory, so that the model may be simulated using simulation software 520 that applies a particular test suite to the hardware model 510 to determine if it indeed functions as intended. In some embodiments, the simulation software is not recorded, captured or contained in the medium.

In any representation of the design, the data may be stored in any form of a machine readable medium. An optical or electrical wave 560 modulated or otherwise generated to transport such information, a memory 550 or a magnetic or optical storage 540, such as a disk, may be the machine readable medium. Any of these mediums may carry the design information. The term “carry” (e.g., a machine readable medium carrying information) thus covers information stored on a storage device or information encoded or modulated into or onto a carrier wave. The set of bits describing the design or a particular of the design are (when embodied in a machine readable medium, such as a carrier or storage medium) an article that may be sealed in and out of itself, or used by others for further design or fabrication.

Having disclosed embodiments and the best mode, modifications and variations may be made to the disclosed embodiments while remaining within the scope of the embodiments as defined by the following claims.

What is claimed is:

1. An integrated circuit comprising:
a first circuit to store a first operand and at least one first value in a first register and to store a second operand and at least one second value in a second register;
a second circuit to perform an arithmetic operation upon values in the first register and the second register to obtain an intermediate result having a first length; and
a third circuit to extract values from the intermediate result to form a result having a second length and that represents an arithmetic operation upon the first and second operands, wherein the second length is less than the first length.

2. The integrated circuit of claim 1, wherein each respective bit of a first N-extra bits of the first value are positioned adjacent to a least significant bit of each respective M-bit segment of the first operand and each respective bit of a second N-extra bits of the second value are positioned adjacent to a least significant bit of each respective M-bit segment of the second operand, wherein N is an integer equal to or greater than 2 and M is an integer equal to or greater than 2.

3. The integrated circuit of claim 2, wherein the values of the first N-extra bits contained in the first register and the second N-extra bits contained in the second register are determined by a type of operation requested by a received instruction associated with the first and second operands.

4. The integrated circuit of claim 3, wherein a value of M is eight and a value of N is 2, 4, 8 or 16.

5. The integrated circuit of claim 1, wherein the first operand comprises a first byte (AL) and a second byte (AH), and the first register includes a first extra bit (A0) inserted before the first byte of the first operand and a second extra bit (A1) inserted before the second byte of the first operand; and the second operand comprises a first byte (BL) and a second byte (BH), and the second register includes a first extra bit (B0) inserted before the first byte of the second operand and a second extra bit (B1) inserted before the second byte of the second operand.

6. The integrated circuit of claim 5, wherein values of the bits A0, A1, B0 and B1 are determined by a type of operation requested by an instruction received with the first and second operands.

7. The integrated circuit of claim 1, wherein the first circuit comprises:
an instruction decoder to decode a received instruction associated with the first and second operands to determine at least one operation requested by the received instruction.

8. The integrated circuit of claim 7, wherein the decoder further comprises:
a table to provide values for a first N-bits of the first value and a second N-extra bits of the second value according to the operation requested by the received instruction.

9. The integrated circuit of claim 1, wherein the second circuit further comprises:
an execution core including an arithmetic logic unit.

10. The integrated circuit of claim 9, wherein the arithmetic logic unit further comprises:
an (N*M)+N-bit single instruction multiple data adder, wherein N is an integer equal to or greater than 2 and M is an integer equal to or greater than 2.

11. A method comprising:
storing a first N*M bit operand and a first N-extra bits in a first (N*M)+N-bit register and a second N*M bit operand and a second N-extra bits in a second (N*M)+N-bit register; and
logically combining values in the first register and the second register to obtain a result having a length of N*M bits, wherein N is an integer equal to or greater than 2 and M is an integer equal to or greater than 2.

12. The method of claim 11, wherein storing further comprises:
positioning each respective bit of the first N-extra bits contained in the first register adjacent to a least significant bit of each M-bit segment of the first operand;
positioning each respective bit of the second N-extra bits contained in the second register adjacent to a least significant bit of each M-bit segment of the second operand;
decoding an instruction received with the first and second operands to determine a type of operation requested by the instruction; and
determining values of the first N-extra bits contained in the first register and the second N-extra bits contained in the second register based on the type of operation requested by the instruction.

13. The method of claim 11, wherein storing further comprises:
inserting a first extra bit (A0) adjacent a least significant bit of a first byte (AL) of the first operand;
inserting a second extra bit (A1) adjacent to a least significant bit of a second byte (AH) of the first operand;
inserting a first extra bit (B0) adjacent to a least significant bit of a first byte (BL) of the second operand;
inserting a second extra bit (B1) adjacent to a least significant bit of a second byte (BH) of the second operand;
querying a table according to the type of operation requested by the instruction to determine values of bits A0, B0, A1 and B1; and
setting the bits A0, B0, A1 and B1 according to the determined values.

14. The method of claim 11, further comprising:
providing the first and second registers to an (N*M)+N-bit adder; and
extracting an N*M bit result produced by the (N*M)+N-bit adder.

15. The method of claim 14, wherein extracting further comprises:
selecting a first byte value from the (N*M)+N-bit result corresponding to a position of AL and BL within the first and second registers;
selecting a second byte value from the (N*M)+N-bit result corresponding to a position of AH and BH within the first and second registers; and
storing the first selected value and the second selected value within a register to produce the result having the length of N*M bits.

16. A machine readable medium having embodied thereon a circuit design for fabrication into an integrated circuit which, when fabricated, comprises:
a first circuit to decode an instruction received with first and second operands to determine at least one first value and at least one second value;
a second circuit to store the first operand and the first value in a first register and the second operand and the second value in a second register; and
a third circuit to extract values from an arithmetic result computed with the first and second registers to obtain a result having a length less than the arithmetic result.

17. The machine readable medium of claim 16, wherein the first value comprises a first N-extra bits and the second value comprises a second N-extra bits, where a value of the first N-extra bits and the second N-extra bits are determined according to a type of operation requested by the decoded instruction and N is an integer.

18. The machine readable medium of claim 16, wherein the integrated circuit further comprises:
an (N×M)+N-bit arithmetic circuit to compute the arithmetic result from the first and second registers, wherein the first and second operands have a length of N×M bits, and the first and second extra values comprise a first N-extra bits and a second N-extra bits, wherein N is an integer equal to or greater than two and M is an integer equal to or greater than two.

19. The machine readable medium of claim 16, wherein the third circuit further comprises:
an arithmetic circuit to perform an arithmetic operation on values in the first register and the second register to obtain the arithmetic result having a length of (N×M)+N bits, wherein the first and second operands have a length of N×M bits, the first value comprises a first N-extra bits and the second value comprises a second N-extra bits; and
result extraction logic to pack at least a first M-bit segment and a second M-bit segment of the arithmetic result within a result register to obtain the result having a length of N×M bits that represents an arithmetic operation upon the first and second operands.

20. The machine readable medium of claim 17, wherein the first circuit further comprises:
a decoder to position each respective bit of the first N-extra bits contained in the first register adjacent to a least significant bit of each M-bit segment of the first operand and to position each respective bit of the second N-extra bits contained in the second register adjacent to a least significant bit of each M-bit segment of the second operand.

21. A system comprising:
at least two digital signal processors coupled together via input and output ports to enable data exchange between each processor, each digital signal processors including at least one processing element, comprising:
an instruction fetch unit to select an instruction having a first operand and second operand, wherein the first and second operands have a length of N*M bits, N is an integer equal to or greater than 2 and M is an integer equal to or greater than 2;
an instruction decoder to decode the selected instruction to determine a value of a first N-extra bits stored with the first operand in a first N*M+N-bit register and to determine a value of a second N-extra bits stored with the second operand in a second (N*M)+N-bit register; and
an execution core to logically combine values in the first register and the second register to obtain a result data having a length of N*M bits.

22. The system of claim 21, wherein the decoder is to decode the received instruction to determine at least one operation requested by the received instruction.

23. The system of claim 21, wherein the decoder further comprises:
a lookup table to provide values for the first and second extra bits according to an operation requested by the received instruction.

24. The system of claim 21, wherein the execution core further comprises:
an arithmetic logic unit.

25. The system of claim 24, wherein the arithmetic logic unit further comprises:
an (N*M)+N-bit single instruction multiple data adder.

26. The system of claim 21, wherein each processor further comprises:
a register file coupled to the processing element, the register file including a plurality of general purpose registers accessible by the processing element;
a memory interface coupled to one or more of the processors; and
a random access memory coupled to the memory interface.

27. The system of claim 21, wherein the at least one processing element further comprises:
an input processing element coupled to the register file, the input processing element to receive input data;
an output processing element coupled to the register file, the output processing element to transmit data;
one or more multiple accumulate processing elements coupled to the register file; and
a general processing element coupled to the register file.

28. The system of claim 21, wherein the system comprises:
a digital media processor.
